(19) United States
(12) Patent Application Publication
(10) Pub. No.: US 2011/0270621 A1
(43) Pub. Date: Nov. 3, 2011

(54) PATIENT-RELATED DATA MANAGEMENT SYSTEM AND METHOD WITHIN THE SCOPE OF AN EVALUATION OPERATION

(76) Inventors: Nicolas Glatt, Paris (FR); Antoine Angenieux, Paris (FR); Thomas Glatt, Paris (FR)

(21) Appl. No.: 12/300,994

(22) PCT Filed: May 15, 2007
(86) PCT No.: PCT/EP2007/054705

§ 371 Date: May 29, 2009

(30) Foreign Application Priority Data
May 15, 2006 (FR) 0604331

(51) Int. Cl. G06Q 50/00; G06Q 10/00

(52) U.S. Cl. 705/2

(57) ABSTRACT

Patient-related data management method within the scope of an evaluation operation conducted in at least one treatment centre (100), characterised in that it comprises the steps consisting of the input of data relating to a patient using at least one input terminal (112) to form a patient record, the validation of said input using a patient application (115), the automatic processing of the patient record by the patient application (115) to form a source record which complies with one or more regulatory requirements, the registration of the source record in a source database (10) deployed in the treatment centre (100) taking part in the evaluation operation, the comparison of the source record data with enrollment criteria provided by the sponsor of the evaluation operation, the pre-enrollment of the source record whereby, in particular, the source record is duplicated automatically to form a potential evaluation record, the registration of the potential evaluation record in a local evaluation database (20) deployed in the treatment centre (100), the enrollment of the potential evaluation record using a local evaluation application (121), the validation of this enrollment step resulting in the export of the data from the potential evaluation record to form a CRF evaluation record in compliance with the sponsor's requirements, the registration of the CRF evaluation record in a database (10) deployed in the treatment centre (100).

The invention relates to methods and systems for managing medical or medical practice-related data and for managing transmission of this data to third parties.

Such management methods and systems are known, for example, for enabling the doctor to enter, onto a computer medium or paper base, information for each patient, which was gathered during a diagnostic or therapeutic procedure.

This data pertains to the clinical state of the patient, the reasons for the exam, as well as the diagnostic and/or therapeutic procedures performed by the care player.

This entire set of data, referred to as “patient data,’ is added to a patient record.

This patient record is retained within the care facility for a legal retention period and constitutes a medico-legal document.

This process is common to all of the patients examined or treated by the care player.

Such management methods and systems are known, for example, for enabling evaluation or control operations to be conducted by physicians and/or paramedics, to ensure the mission of materials vigilance and pharmacovigilance, and traceability of the materials and products required for patient diagnostic and treatment procedures. Physicians and/or paramedics are hereinafter designated by the term “care players”.

An evaluation or control procedure consists of a generally prospective study conducted in one or more care facilities, and aims at testing the tolerance and/or efficacy and/or proper use of medical materials, drugs or method of care.

This study is structured around a protocol which, for each study, defines:

the question to which the study must provide a response,

the conditions for including and excluding patients,

a set of structured forms enabling compilation of the data required in order to formulate the response. This compilation is hereinafter designated by CRF (current term in the medical community for “Case Report Form”).

the patient follow-up steps included in the operation and the information that must be collected during these follow-ups.

The objective of an evaluation procedure such as this can be to serve as a basis for a scientific research, economic or regulatory study. All of these procedures are hereinafter designated by the term “evaluation operation”.

The persons requiring such evaluation operations can therefore be persons from the medical profession, researchers, project leaders, care center managers, or else manufacturers whose activity relates to the design or distribution of medical, surgical products, etc. These persons, for example, belong to sponsoring organizations, patient associations, insurance companies, learned societies, companies, etc. Any person organizing an evaluation operation is hereinafter designated by the term “sponsor”.

Within the scope of this evaluation operation, the care players accept to transmit information concerning some selected patients to the sponsors.

Each of these patients signs a consent, which authorizes the transmission of their data to a sponsor, under protection of anonymity.

Each patient is said to be “included” in the evaluation operation.

This information is of a very diverse nature and includes data relating to the patient's demographic, epidemiological, physical, physiological, pathological or mental characteristics.

This information likewise pertains to the medical and/or surgical care provided or to be provided, as well as the various products which may be used to provide this care.

This information is particularly sensitive, personal and confidential. The use thereof is thus subject to numerous restrictions and specific regulations.

The current processes and tools for managing this information will now be described, by explaining the inherent constraints in managing an evaluation operation. The disadvantages of the current processes and tools will likewise be highlighted.

When a care player participates in an evaluation operation, they agree to transmit to the sponsor all or part of the data from the patient record.

When a patient is included in an evaluation operation, the care player creates a CRF.

This CRF is provided to the care players by the sponsor of the evaluation operation, either on a paper base or on a computer medium.

Once the CRF has been created for the patient, the care player must make a copy therein of the information contained in the patient's medico-legal record.

The information thus recaptured is designated as evaluation data and comprises the evaluation records data.

In this way, for each evaluation record, and from the patient record, the care player must:

verify that the “patient” data corresponds to the inclusion and exclusion criteria established by the sponsor,

input the new data collected during the diagnostic or therapeutic procedure,

ensure follow-up of the patients at a frequency defined by the protocol for the evaluation operation,

ensure updating of the evaluation record via the statement of possible events to occur during the follow-up period.

Furthermore, the constraints and strict regulations which apply to the use of medical data involve special processing. These constraints and regulations require, in particular, that the signature of the care player, or care players, having input or modified data from the evaluation record be affixed to this data, that the data provided be traceable, and that the data transmitted be anonymous.

The evaluation data from each care facility participating in the evaluation operation is centralized and consolidated in a database.

Furthermore, to be relevant, the data provided by the care players must be subject to a consistency check. This step, which is referred to as the verification step, auditing step, or else monitoring step, involves travel by the assistants or contractors of the sponsor to each of the care facilities.

These assistants or contractors then verify all or part of the evaluation data by comparing the data contained in the evaluation record being managed by the sponsor with the patient data contained in the patient records. The verification relates to both the accuracy of the data transferred as well as to the existence of patient data that has not been re-input into the evaluation records. This step therefore requires that a person specifically trained and authorized to verify medical data travel to each center, and that the health player prepare the patient records required for this verification step.

When the evaluation data has been verified, it can be used statistically to enable response to the question stated in the protocol. The current processes have numerous disadvantages which pertain to capture of the evaluation data and the verification thereof as well as to the use of same.

Regardless of a care player's motivations for participating in such an operation, they are compelled to determine or at least allocate the resources required for re-inputting the patient record data into the evaluation record, for applying the regulatory recommendations, for updating the evaluation record with the information added to the patient record, or coming from colleagues during the evaluation operation time, and for physically searching the patient records.

These constraints prove to be particularly tedious and limit the involvement of the care players, however critical, in this type of clinical evaluation operation.

Furthermore, the current process involves a time lag between input of the patient data and the availability of the evaluation data that can be used by the sponsor.

This time lag is a result of the time required for re-inputting the data, for the routing thereof (if the medium is paper), and for verifying the evaluation data. This time lag limits the efficiency of the evaluation operations.

In addition, verification of the transmitted data is in actual practice absolutely necessary for ensuring that it is appropriate for the data received by the sponsor to be used. For the sponsor, this verification phase represents a significant loss of time, a considerable personnel requirement, and results in a substantial financial burden.

Furthermore, the disadvantages of the current processes substantially limit the relevancy of the results derived from the use of the evaluation data.

Over a given time period, the primary purpose of the evaluation operations is:

either to collect the data from all of the records meeting a set of well-defined, selective (study) criteria,

or to provide a true and complete overview for a single criterion (use of a item of material, etc.).

In order to conduct this type of evaluation operation, the sponsor centralizes and manages the evaluation data coming from several facilities over a specific time period. The relevancy of the results of these operations is based on the conditions of completeness and consecutivity.

The condition of completeness means that all of the patients who were subject to a given treatment are included in the evaluation operation.

The condition of consecutivity requires that all the patients demonstrating defined criteria be subjected to a given treatment and therefore be included in the evaluation operation.

This being said, in actual practice, these two conditions are not necessarily observed. As a matter of fact, it quite often proves true that certain data is not included, in particular due to an input omission, product anomaly, or else a procedural malfunction. In actual practice, faulty use of an item of material during the diagnostic or therapeutic procedure results in the non-inclusion of the patient by the care player. Therefore, no information will be returned to the sponsor following use of this material. Such being the case, the difficulty in using an item of material can be very important information for a sponsor. For example, such information can lead a sponsor to improve a product so as to reduce the faulty use thereof, and, more generally speaking, makes it possible to accurately monitor material inventories. Each piece of information, even those relating to failures to implement an item of material, product or method, contributes to improving care conditions and, for this reason, should be used within the framework of an evaluation operation.

Therefore, the input step of the current processes does not make it possible to guarantee that the conditions of completeness and consecutivity will be observed.

In general, the current processes do not make it possible to easily verify that all of the patient records, the data of which meets the criteria selected by the sponsor, have actually been recorded and re-input, with some data having been forgotten, omitted or disregarded.

Besides the aforesaid disadvantages related to the selection, input, transmission and use of the data, the current processes and tools for managing clinical information have other restrictions.

As stated previously, the re-inputting of patient data is accompanied by reprocessing, in order to make this data compliant with requirements and regulations (e.g., the anonymity requirement). This reprocessing may therefore involve error since it does not consist in simply duplicating the set of data.

The sponsor of an evaluation operation defines a certain number of criteria that a patient record must have in order for the data contained therein to be included in an evaluation operation.

Re-inputting of the data thus requires verification that the criteria are consistent with the data from each patient record. This verification requires an additional effort on the part of the care player, results in an additional workload, and represents a significant risk of error.

The current processes thus have disadvantages related to the reprocessing of patient data, whether required for compliance with regulations or with sponsor requirements.

Furthermore, the current processes do not guarantee a sufficient level of security suited to the sensitivity of the captured data.

This lack of security relates to both the accessibility of the information as well as to the possibility of modifying this information.

As a matter of fact, the current processes do not propose means of verifying the identity of the persons wanting to access data or wishing to add or modify data.

Neither do these processes enable automated traceability of the added or modified data.

Furthermore, on the paper forms, the signature that must accompany every entry or modification of data can be easily imitated.

Therefore, the security of the current processes appears to be limited.

Furthermore, the current processes do not enable an evaluation operation to be carried out a posteriori, i.e., to conduct an evaluation operation using data input prior to launching the study. As a matter of fact, an a posterior evaluation operation would require searching among the previously input patient records for those containing data which satisfies the inclusion criteria defined by the sponsor. Such being the case, a search such as this is based on the patient data and, for this reason, is not authorized, since this patient data does not comply with the specific regulations for managing evaluation operations.

These processes for transmitting data between a care facility and third parties likewise has disadvantages related to managing material depositories. The term material, within the meaning of the present invention, includes all of the medical and surgical drugs, products and materials used for diagnosis and treatment.

The on-going evolution of medical materials is generally accompanied by a substantial increase in the unit price thereof. This increase in prices has significant consequences for the distribution of same, and, therefore, many material manufacturers do not sell their materials to care facilities when they are delivered to these facilities but remain the owner thereof until the actual consumption of same.

Therefore, manufacturers deposit a specific quantity of material made available to the care facility. Each item of material is billed to the care facility only after the actual use thereof.

Increasing prices and the moment at which the transfer of ownership occurs requires accurate management of the material depositories. This management requires, in particular, that information relating to the used and unused inventory of materials be made available to the manufacture as expeditiously as possible, in order to ensure replenishment of the inventories and to initiate invoicing of the consumed materials.

This information currently travels within the care facility, either via the company store and is only transmitted to the manufacturer secondarily according to the timeframes specific to each facility.

Furthermore, the manufacturer cannot differentiate between lost material, defective material, unsuccessfully used material or material that has been mistakenly desterilized. Such being the case, from the standpoint of material experience feedback, as well as from the financial standpoint, this information is very important. In actual practice, the sponsor of an evaluation operation attempts to obtain this information during an on-site visit by one of their representatives.

Identification of the materials is based on systems specific to each material supplier. These systems are numerous and are not subject to any international standardization. As a general rule, the identification of medical materials is managed within each care facility, not per unit, but by type and batch of material.

Thus, for example, the characteristics of the materials (manufacturer, item name, etc.) are input manually, the bar codes are manually recaptured and an internal catalog is gradually compiled.

This practice results in a great loss of time, involves a great risk of error, difficult updating, and does not enable reliable traceability of the medical materials.

Such being the case, material manufacturers should and will have to enable physicians to identify their material in a unique manner in order to enable them to carry out their mission of traceability and materials vigilance under the best conditions.

Thus, the current processes have numerous disadvantages relating to the inputting of data, the transmission of same, the use of same, as well as the management of medical material depositories.

The invention aims to improve the current processes and systems for managing information relating to diagnostic or therapeutic case management of a patient in a medical setting and for transmitting information relating to this case management to third parties.

The object of the invention is a set of applications enabling the management of this information to be optimized.

In order to accomplish these objectives, within the scope of the present invention, a method is provided for managing patient-related data within the framework of an evaluation operation conducted in at least one care center, comprising the steps of:

inputting data relating to a patient from at least one input terminal, in order to compile a patient record,

validation of this input from a patient application,

automated processing of the patient record via the patient application, in order to compile a source patient record which complies with one or more regulatory requirements,

recording of the source patient record in a source database deployed in the care center,

comparison of the source record data with inclusion criteria provided by the sponsor of the evaluation operation,

pre-inclusion of the source record from which, in particular, the source record is automatically duplicated in order to compile a potential evaluation record,

recording of the potential evaluation record in a local evaluation database deployed in the care center,

inclusion of the potential evaluation record using a local evaluation application; validation of this inclusion step resulting in the exportation of the data from the potential evaluation record in order to create an evaluation record (CRF) complying with the sponsor requirements,

recording of the evaluation record (CRF) in a database deployed in the care center.

The management method according to the invention may also optionally have at least one of the following characteristics:

validation of the pre-inclusion is carried out during the input validation,

validation of the pre-inclusion is carried out after the input validation,

validation of the pre-inclusion likewise results in a step for reprocessing the potential evaluation record which, in particular, includes making this record anonymous,

comparison between the inclusion criteria provided by the sponsor of the evaluation operation and the data present in the source record is carried out by a person or a search engine,

the management method comprises a step for modifying the data in or adding data to the evaluation record (CRF), a step for validating completion and automatic recording of the evaluation record (CRF) thus modified,

validation of the input, and/or validation of the pre-inclusion, and/or validation of the inclusion, and/or validation of the completion, comprises a step for controlling access by the person performing the validation, and a step for collecting and recording information enabling traceability of the validation,

the evaluation record (CRF) is transmitted to a central evaluation database to which the sponsor of the evaluation operation has access,

several care centers participate in the evaluation operation, while the central evaluation database collects the evaluation records (CRF) relating to this evaluation operation in each of the care centers,

synchronized modification of the potential evaluation record,

modification of the evaluation record (CRF) automatically results in a synchronized modification of the evaluation record (CRF) contained in the central evaluation database,

data contained in the source records is transmitted to a material module enabling management of the material inventories,

the steps of inputting data into the patient source record and of inclusion in an evaluation operation are validated simultaneously by a single operation using the patient module,

the data contained in the source records is compared with the material-related data, this data being contained in a material module, and it is verified whether material data for used material is included in an evaluation record (CRF) so as to meet the completeness requirement,

data contained in the source records is compared with the material-related data, this data being contained in a material module, and it is verified whether each patient possessing the inclusion criteria has been subject to treatment associated with this criteria, so as to meet the consecutivity requirement.

Another object of the invention is a system for managing patient-related data within the framework of an evaluation operation conducted in at least one care center, comprising:

a patient module comprising:
at least one terminal for inputting data relating to a patient, in order to create a patient record,
a patient application enabling validation of this input, the patient application performing automated processing of the patient record in order to compile a source record which complies with one or more regulatory requirements,

a source database, deployed in the care center participating in the evaluation operation and in which the source record is recorded,

means for automatically duplicating the source record in order to create a potential evaluation record,

a local evaluation database, deployed in the care center and in which the potential evaluation record is recorded,

a local evaluation application exporting data from the potential evaluation record in order to compile an evaluation record (CRF) complying with the sponsor requirements,

a database, deployed in the care center and in which the evaluation record (CRF) is recorded.

Other characteristics, purposes and advantages of this invention will become apparent upon reading the following detailed description, and with reference to the appended drawings provided for non-limiting illustrative purposes, in which:

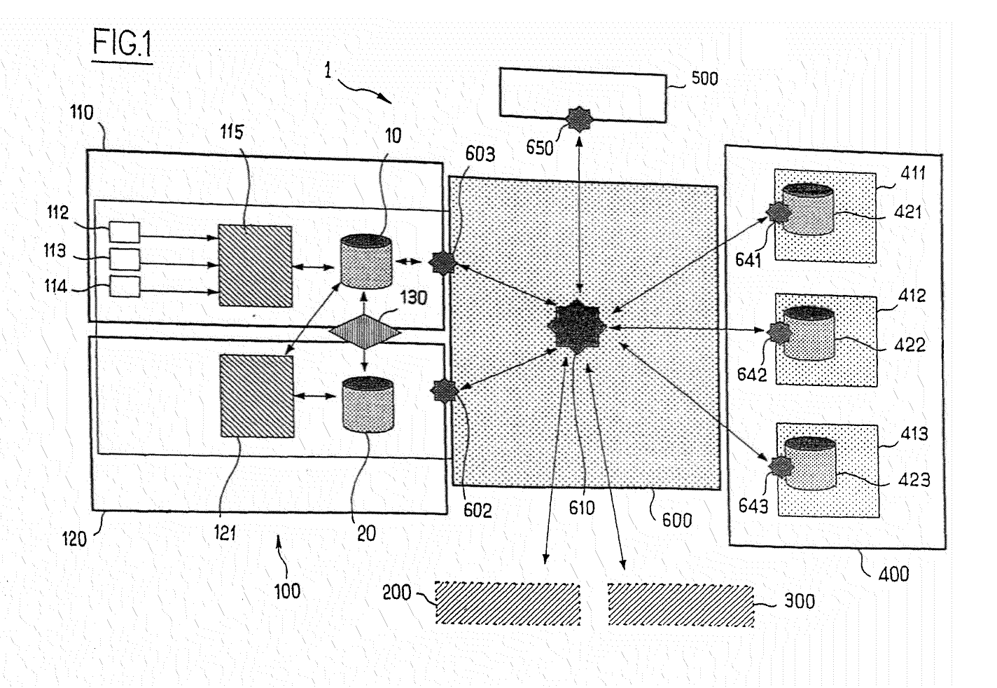

FIG. 1 is a diagram of a data management system according to a first exemplary embodiment,

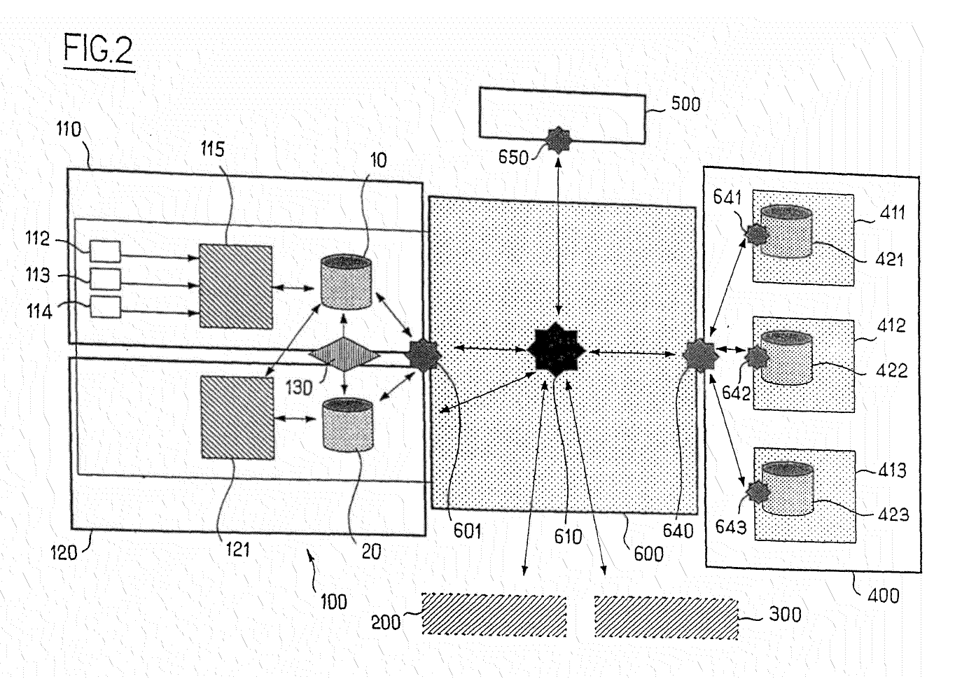

FIG. 2 is a diagram of a data management system according to a second exemplary embodiment.

With reference to FIG. 1, the data management system 1 according to one exemplary embodiment has been illustrated.

This management system 1 comprises, in particular, a patient module 110 enabling the input of patient-related data, a local evaluation module 120 for the data derived from the patient module 110 in an evaluation operation, and a module for synchronizing 130 the data between 110 and 120, these three modules being deployed in each of the care centers. The system likewise includes three modules common to all of the care centers:

a central evaluation module 400 enabling centralization of the data from the local evaluation module 120 of each of the care centers 100, 200, 300.

a central server module 600 ensuring management of the messages between the various system modules,

a material module 500 managing the information relating to the equipment, drugs and, in general, the products used for diagnosis and treatment of the patients.

The information management system 1 will now be described by following the primary data flow.

### Patient Module 110

The patient module 110 comprises one or more input terminals 112, 113, 114. These input terminals 112, 113, 114 are localized in an operating room, or a premises of a care center 100. These terminals enable inputting of patient-related data. They offer various means of input:

manual input by means of a computer keyboard or graphics tablet,

input via a bar code reader placed on a product or patient,

automated input carried out by recapturing information coming from the hospital information system of the care facility (number, bar code, microchip . . . ),

automated input carried out by a piece of healthcare equipment taking data from the patient directly.

These input operations are carried out on standardized forms for diagnostic or treatment procedures administered to the patient.

All of the patient-related data contained in these forms constitutes a patient record.

The patient module 110 likewise comprises a patient application 115.

Prior to or after inputting, the patient application 115 verifies the identity of the person wishing to validate the input. This verification can be carried out using a password or by means of biometric verification. The person whose identity is verified and who is authorized to input data can then proceed with validation of the input. This person, generally a physician or medical professional, is hereinafter designated as an authorized person.

The patient application 115 next carries out processing of the data. This processing enables the input data to be converted so as to comply with a certain number of regulatory requirements. These regulatory requirements, for example, require that each inputting of data be validated by means of a signature affixed by the authorized person. To that end, the patient module 110 comprises means enabling a signature to be affixed via electronic means, for example, or by using a professional health card. These regulatory requirements likewise require that each addition or modification of data be completely traceable. Such traceability includes, in particular, the identity of the authorized person, the date of input, the subject matter of the input, etc.

The input data thus reprocessed takes on a source character and retains this source character irrespective of the subsequent processing applied thereto.

This data is hereinafter designated as source data, the entire set of this patient-related data is designated as a source record and all of the source data contained in the source records constitutes a database referred to as a source database.

This patient database 10 is part of the patient module 110 and is located in the care center 100.

This source database communicates with another database belonging to local evaluation module 120, and which is also located in the care center 100. This other database is referred to as the local evaluation database 20.

### Local Evaluation Module 120

The inclusion of a patient in an evaluation operation means that data relating to this patient will be used within the framework of the evaluation operation.

The sponsor of an evaluation operation defines a certain number of criteria referred to as inclusion criteria, which the data from patient record must meet in order to be included in the evaluation operation.

For the sake of simplifying language, the expression record inclusion is used to signify that a patient's data is being collected for the purpose of being used within the framework of an evaluation operation.

The local evaluation module 120 comprises a local evaluation application 121 and a local evaluation database 20.

The local evaluation application 120 enables receipt of an evaluation operation initialization request. An evaluation operation initialization request contains all of the instructions necessary for conducting an evaluation operation in accordance with the sponsor requirements and regulatory recommendations. Such a request therefore includes the following information, in particular:

the list of persons authorized to include, complete and affix a signature to evaluation data. These persons are hereinafter designated as investigators,

the medical, scientific or industrial objective sought after by the evaluation operation,

the criteria that a patient must meet to be included in a study. These criteria correspond to diagnostic procedures, to care or treatment provided, or else to any other data capable of appearing in a source record,

the forms specific to the evaluation operation, hereinafter designated as evaluation or CRF records, and the control and consistency rules applied to these forms,

the protocol details to be observed for:
taking the data from the patient
inputting this data onto a form
completing the form with other data.

In an evaluation operation, the patient module 110 enables pre-inclusion of a source record directly from the patient application 115, without any recapture, during:

input of the information relating to the patient's clinical state, and to the diagnostic or therapeutic procedure carried out by means of terminals 112, 113, 114.

subsequent consultation of the patient record.

On the basis of the request received by the evaluation module 120, the authorized person decides whether a source file should or should not be included in a given evaluation operation. This choice by the authorized person generally results from a comparison between the inclusion criteria defined in the request provided by the sponsor and the data present in the source record.

According to one alternative, the pre-inclusion operation is carried out at the local evaluation module 120 level. In this case, comparison of the inclusion criteria and source data can be performed automatically by the local evaluation application 121.

The possibilities of carrying out the pre-inclusion operation from the patient module 110 and from the evaluation module 120 are both shown in FIGS. 1 and 2.

Validation and pre-inclusion can be made subject to this person's authorization, and can likewise be subject to the affixing of an electronic signature.

This pre-inclusion consists in:

automatically duplicating a source file in order to create a copy of the source file,

putting this copy through an inclusion processing operation,

recording this copy in the local evaluation database 20.

This pre-inclusion processing, for example, consists in making the entire copy of the source file anonymous so as to delete any information related to the legal personality of the patient, the data of which constitutes the source file. Other processing may be anticipated, e.g., such as the addition of information relating to the pre-inclusion step, so as to enable this step to be traced. This information can be input manually or can be added automatically when the input is validated.

The copy of a source file made by duplicating means is hereinafter referred to as a potential evaluation record. This potential evaluation record is contained in the local evaluation database 20.

Security means substantially identical to the means providing access security to the patient application 115 and source database makes it possible to control access to the local evaluation application 121 and to the local evaluation database 20. In this way, only the investigators can access the local evaluation module 120.

Validation of inclusion is subject to the affixing of an electronic signature by the investigator. This affixation is carried out by the investigator in application 121.

The data contained in the potential evaluation record the inclusion of which is validated is then exported to the forms specific to the evaluation operation, and constitute an evaluation record, which is also hereinafter designated as the CRF. This CRF is then recorded in the local evaluation database 20.

In another exemplary embodiment, the potential evaluation record and the CRF are recorded in separate databases located in the care centers.

As soon as a CRF is recorded in the local evaluation database 20, the information contained in this CRF is made accessible to the sponsor of the evaluation operation. The details of the transmission of the CRF from the care center to the sponsor are explained below.

When a record is included, the local evaluation application 121 then shows if all of the data required by the sponsor in the request is present in the CRF.

If need be, and according to the management rules specific to the protocol for the evaluation operation, the evaluation application 121 enables the investigator to complete or modify the CRF data for the duration of the evaluation operation. These modifications will be carried out by the investigator in various ways, depending on the origin of the data.

If the data comes from the patient record, the investigator must modify the source of the data from application 115. This modification will result in the generation of a request of compliance of the patient record data with the CRF data.

If the data is not present in the patient record, this modification is carried out by the investigator from application 121.

Any modification of a CRF is governed by strict management rules which aim to ensure complete traceability of the data, e.g., the affixation of the investigator's signature, the generation of a modification trace and the reason for this modification. This traceability is available from modules 120 and 400.

The inclusion and completion of CRFs are secured by appropriate safeguarding means (access control, etc.).

The local evaluation database 20 thus comprises both potential evaluation records, which require validation by the investigator, and CRFs.

A CRF complies with both the regulatory requirements and those set forth by the sponsor, from the standpoint of the data that it contains, as well as from the standpoint of the presentation of this data.

A request supplied by a sponsor is specific to an evaluation operation; consequently, a CRF which is included on the basis of such a request is likewise specific to an evaluation operation.

Automated processing of the input data into source data and automated duplication of the source data to compile a potential evaluation record makes it possible to not have to recapture the information contained in a source record.

The management system 1 thus enables substantial savings in time and cost reductions associated with recapturing information and with the necessary control thereof.

Completion of a CRF is likewise facilitated, and the risks associated with retranscription errors or omissions are also eliminated.

The sponsor is thereby ensured of having reliable data for conducting their evaluation operation. Verification of the data can then be limited solely to the data not present in the source record.

In addition to enabling a substantial savings in time and a reduction in the risks of error, automated inputting and duplication of source data relieves the authorized persons from a significant constraint, and, as a result, makes them more disposed to be involved in this type of evaluation operation.

The authorized persons likewise possess a single evaluation application 121 for managing all of the evaluation operations in which they participate. This contributes to reducing the time required by the investigator to acquire the solution and limits the resources required by the sponsor to ensure the transfer of authority.

Furthermore, the data serving as a basis for the creation of the CRFs is source data which, by definition, complies with the regulatory requirements associated with the handling of this data. It is possible to manipulate this data at any time since this source character is retained over time. Thus, the management system 1 enables an evaluation operation to be carried out a posteriori, i.e., to conduct an evaluation operation using data input prior to the initialization of this same operation.

According to an alternative, the management system 1 likewise comprises a multi-criteria search engine associated with a patient database 10. The search engine makes it possible to receive search instructions which are established by the investigator when an a posteriori evaluation operation is requested. It is likewise provided for the sponsor wishing to initialize an evaluation operation to be able to launch such a search directly. Launching of this search by the sponsor is subject to the legal consent of the investigator. Obtaining this consent can be controlled by appropriate control means, such as access codes, etc.

The search engine identifies all the source records which correspond to the criteria set forth in the request. As a result, the search engine then delivers the list of all of these source records.

The investigator then determines the desired records to be included in the evaluation operation. The evaluation application generates as many CRFs as there are source records selected in the search result, these CRFs containing the data contained in the selected source records. These CRFs are recorded in the evaluation database 20.

The management system 1 makes it possible to carry out this type of a posteriori evaluation operation since the search engine carries out its search on data which assumes a source character and which can therefore be manipulated. The systems and processes of the prior art do not enable a posteriori evaluation operations to be carried out, since they do not propose databases which compile all of the records that have been input and the data of which assumes a source character.

The use of standardized forms for inputting patient data enables efficient management of this information, irrespective of the protocols of the various sponsors.

Among other things, the secure access conditions and the traceability information makes it possible to comply with the medico-legal requirements relating to this data.

According to an alternative, inclusion in an evaluation operation can be carried out by the investigator directly from the patient module 110, at the time the source record is created. Validation of the input and validation of the inclusion is then carried out in a single operation by one and the same person. In this case, the CRF is created directly by the evaluation module 120, without any separate validation of the pre-inclusion being required of the operator.

In particular, this alternative introduces a time savings and versatility in creating a CRF.

### Central Evaluation Module 400

The server module 600 enables management of the messages between the care centers 100, 200, 300 and the central evaluation module 400.

When a CRF is created, it is then transmitted from the local evaluation database 20 to the central evaluation module 400 by means of application 600. This central evaluation module 400 is a web application, including central evaluation applications 411, 412, 413. Each of these central evaluation applications 411, 412, 413 is associated with a central evaluation database 421, 422, 423, respectively.

For each of the central evaluation applications 411, 412, 413, the central evaluation module 400 likewise comprises a client application 641, 642, 643. The role of a client application 641, 642, 643 is to establish communication between the central evaluation application with which it is associated and the various modules of the management system 1.

The central server module 400 enables collection of the CRFs from all of the care centers 100, 200, 300 participating in evaluation operations.

Each of the central evaluation databases 421, 422, 423 is specific to a particular evaluation operation, and contains the CRFs of all the care centers which are specific to this evaluation operation. Thus, the central evaluation module 400 contains as many central evaluation applications 411, 412, 413 and as many central evaluation databases 421, 422, 423 as there are evaluation operations.

The diagram of FIG. 1 thus shows three central evaluation applications 411, 412, 413, each associated with a central evaluation database 421, 422, 423, each of these central databases compiling the CRFs relating to a specific evaluation operation.

The sponsor of an operation accesses the CRFs contained in the central evaluation database corresponding to the evaluation operation that they initiated. This access is controlled by means of appropriate devices such as access codes.

### Central Server Module 600

Transmission of the data between the various modules is detailed more specifically in this part.

The central server module 600 includes a central server application 610 which is an application dedicated to managing the messages between the care centers 100, 200, 300 and the modules 400 and 500.

This message management application ensures compliance of the exchanges conducted within the system with the legal recommendations and obligations.

This application, for example, manages the encoding and safeguarding of the information flow between the various system applications, the non-repudiation of the information, and, in general, any process that must be implemented in order to ensure the users of the system of compliance with the laws in force.

The central server application 610 manages the information flows and the routing of same to the various modules of the system.

Modules 110, 120, 400 and 500 each comprise a client application, referenced as 603, 602, 650, 641, 642 and 643, respectively.

The central server module 600 enables communication between the various modules 110, 120, 400, 500, via the respective client application thereof 603, 602, 650, 641, 642, 643.

Module 600 can ensure synchronous or asynchronous management of the messages sent by modules 110, 120, 400 and 500, based on user needs.

In this way, the client application 602 associated with the local evaluation application 121 contained in the local evaluation module 120 establishes either synchronous or asynchronous secure communication, for example, with the central server application 610.

When a CRF is created, the client application 602 sends a message to the client application 641, 642 or 643 which is dedicated to the evaluation operation for which the CRF is generated.

The central evaluation database associated with this client application collects newly created CRFs.

With reference to FIG. 2, an exemplary management system 1 having another configuration for managing messages is proposed.

In this example, modules 110 and 120 comprise a common client application 601. This common client application ensures communication between the central server application 610 of the central server module 600 and the applications 115, 121 and databases 10, 20 of modules 110 and 120.

Therefore, client applications 602, 603 do not communicate directly with the central server application 610.

In this same example, the central evaluation module 400 comprises a client application 640 which ensures communication between the central server application 610 of the central server module 600 and the client applications 641, 642, 643.

Therefore, client applications 641, 642, 643 do not communicate directly with the central server application 610.

It is obviously possible to anticipate other message management structure configurations, and particularly structures comprising only one of the client applications 601 or 640.

### Synchronization of the Data

The management system 1 likes includes a synchronization application 130 dedicated to controlling synchronization of a data item between the patient record and the CRF, within the care center 100.

Thus, following a new input of data, when the source data are modified while observing the conditions for taking on a source character, an application enables synchronization of the source records data and the data from the CRFs.

In the same way, when a CRF is modified, and when this modification is validated by the investigator, the data from this CRF is synchronized with that from the CRF contained in the central database.

This synchronization of the data makes it possible to ensure real-time compliance with the data input by the authorized person and the data used by the sponsor.

Verification of the data by an auditor is thus limited to the data not present in the patient record.

This synchronization of the data enables the sponsors to have useful information as soon as same has been input by the authorized person.

As a matter of fact, the time required for verifying and routing the data is reduced considerably.

### Material Module 500

The system for managing 1 patient-related information in a medical setting makes it possible to improve traceability, to facilitate the mission of materials vigilance on the part of the care players, and accurate management of the material inventories.

The material manufacturers possess a tool dedicated to managing material inventories. This tool, which is designated as a material module 500, is associated with central server module 600 application. It includes one or more client material applications and one or more material databases (not shown).

The system enables each manufacturer to create a catalog of materials.

This catalog is a repository of products which observes the descriptive nomenclatures of the products specific to each manufacturer.

Within their repository, the material manufacturer, as a user, can create a new reference, modify a reference or else archive a reference.

The material module 500 establishes a connection with all of the care facilities equipped with the patient application 115, via the client application 603 (or 601 in the case of the configuration of example 2), and transmits the updates made to the various catalogs.

The material items are provided with a bar code, or with a radio-frequency label provided by the manufacturer in consistency with the catalog thereof.

Each material item is identified when introduced into the care center 100 inventory, when removed from the inventory and when used. In some cases, it may be provided to identify the material item at only one of the steps of the removal from inventory or use thereof.

This monitoring of each of the items of material enables very precise knowledge concerning the material inventory.

Each time that an item of material is added to the inventory, removed from the inventory or used, the patient application 115 establishes a connection with the material module 500 and transmits to save the information relating to this addition, removal or use. The manufacturers and users of the material module 500 can thereby consult the status of the inventory for each of the care centers.

However, the information transmitted by the material module 500 to the patient application 115 is not limited to the inventory level. Thus, the patient application 115 transmits to the material module 500 other information concerning the status of each of the items of material, e.g., such as information relating to the date of expiration of this material. Therefore, provisions can be made for an alert to be transmitted by the patient application 115 to the material module 500 when the expiration date of an item of material has matured.

The manufacturers thereby have real-time means of inventory management control.

All information relating to the material, and in particular to inventory in-take, inventory removal, use, type, expiration date, and instructions and precautions, is hereinafter designated as material-related information.

Furthermore, the patient application 115 makes it possible to report that an item of material has been damaged, has not been used successfully or has been mistakenly desterilized. This information makes it possible to initiate materials vigilance procedures, and to provide the manufacturers with accurate data for improving this type of material.

This improved inventory management leads to more accurate production, provisioning and billing schedules, which ultimately results in notable improvements in the quality of the services offered and in the financial return.

In addition to the aforesaid advantages, the system makes it possible to meet the conditions of completeness and consecutivity, which are necessary to the relevancy of an evaluation operation.

As a matter of fact, a search based on the inclusion criteria established by the sponsor makes it possible to identify all of the patients meeting these inclusion criteria. The processing provided for in the protocol will be applied for each of these patients. Verification of the condition of consecutivity is thereby ensured.

Furthermore, when a patient has undergone a particular treatment carried out with a given item of material, the sponsor has the information relating to the use of this material, owing to the material module 500. As a matter of fact, and as indicated previously, it is possible to monitor a given item of material from the material module 500. Therefore, even if the information relating to the treatment undergone by the patient is not included in the evaluation operation, the information relating to the material used during this treatment makes it possible to detect the omission of the inclusion related to the treatment.

Any omission of inclusion can therefore be detected and corrected. Provision can be made for the detection of an omitted inclusion to be accompanied by an alert. The condition of completeness is then observed and makes it possible to verify the notion of “study with an intent to use” or of producing “non-inclusion registries”.

This invention is not limited to the embodiments described above, but extends to any embodiment in accordance with the spirit thereof.

In particular, the number of care centers involved in an evaluation operation managed by the system according to the invention is not limited to three, as in the specified example.

1. Method for managing patient-related data within the framework of an evaluation operation conducted in at least one care center (100), characterized in that it includes the steps of:
inputting data relating to a patient from at least one input terminal (112), in order to compile a patient record,
validation of this input from a patient application (115),
automated processing of the patient record via the patient application (115), in order to compile a source patient record which complies with one or more regulatory requirements,
recording of the source patient record in a source database (10) deployed in the care center (100),
comparison of the source record data with inclusion criteria provided by the sponsor of the evaluation operation,
pre-inclusion of the source record from which, in particular, the source record is automatically duplicated in order to compile a potential evaluation record,
recording of the potential evaluation record in a local evaluation database (20) deployed in the care center (100),
inclusion of the potential evaluation record using a local evaluation application (121); validation of this inclusion step resulting in the exportation of the data from the potential evaluation record in order to create an evaluation record (CRF) complying with the sponsor requirements,
recording of the evaluation record (CRF) in a database (10) deployed in the care center (100).

2. Method of the preceding claim, characterized in that validation of the pre-inclusion is carried out during validation of the input.

3. Method of claim 1, characterized in that validation of the pre-inclusion is carried out after validation of the input.

4. Method as claimed in any of the preceding claims, characterized in that validation of the pre-inclusion likewise results in a step for reprocessing the potential evaluation record which, in particular, includes making this record anonymous.

5. Method as claimed in any of the preceding claims, characterized in that comparison between the inclusion criteria provided by the sponsor of the evaluation operation and the data present in the source record is carried out by a person or a search engine.

6. Method as claimed in any of the preceding claims, characterized in that it comprises a step for modifying the data in or adding data to the evaluation record (CRF), a step for validating completion and automatic recording of the evaluation record (CRF) thus modified.

7. Method of the preceding claim, characterized in that validation of the input, and/or validation of the pre-inclusion, and/or validation of the inclusion, and/or validation of the completion, comprises a step for controlling access by the person performing the validation, and a step for collecting and recording information enabling traceability of the validation.

8. Method as claimed in any of the preceding claims, characterized in that the evaluation record (CRF) is transmitted to a central evaluation database to which the sponsor of the evaluation operation has access.

9. Method as claimed in any of the preceding claims, wherein several care centers (100, 200, 300) participate in the evaluation operation, while the central evaluation database (421, 422, 423) collects the evaluation records (CRF) relating to this evaluation operation in each of the care centers (100, 200, 300).

10. Method as claimed in any of the preceding claims, wherein a modification of the source record automatically results in a synchronized modification of the potential evaluation record.

11. Method as claimed in any of claims 8 to 10, wherein a modification of the evaluation record (CRF) automatically results in a synchronized modification of the evaluation record (CRF) contained in the central evaluation database (421).

12. Method as claimed in any of the preceding claims, wherein the data contained in the source records is transmitted to a material module (500) enabling management of the material inventories.

13. Method as claimed in any of the preceding claims, wherein the steps of inputting the data into the source patient record and of inclusion in an evaluation operation are validated simultaneously in a single operation using the patient module (110).

14. Method as claimed in any of the preceding claims, wherein the data contained in the source records is compared with the material-related data, this data being contained in a material module (500), and it is verified whether material data for used material is included in an evaluation record (CRF) so as to meet the completeness requirement.

15. Method as claimed in any of the preceding claims, wherein data contained in the source records is compared with the material-related data, this data being contained in a material module (500), and it is verified whether each patient possessing the inclusion criteria has been subject to treatment associated with this criteria, so as to meet the consecutivity requirement.

16. System for managing (1) patient-related data within the framework of an evaluation operation conducted in at least one care center (100), characterized in that it includes:
a patient module (115) comprising:
at least one terminal (112) for inputting data relating to a patient, in order to create a patient record,
a patient application (115) enabling validation of this input, the patient application (115) performing automated processing of the patient record in order to compile a source record which complies with one or more regulatory requirements,
a source database (10), deployed in the care center (100) participating in the evaluation operation and in which the source record is recorded,
means for automatically duplicating the source record in order to create a potential evaluation record,
a local evaluation database (10), deployed in the care center (100) and in which the potential evaluation record is recorded,
a local evaluation application (121) exporting data from the potential evaluation record in order to compile an evaluation record (CRF) complying with the sponsor requirements,
a database (20), deployed in the care center (100) and in which the evaluation record (CRF) is recorded.
